(19) United States
(12) Patent Application Publication
(10) Pub. No.: US 2022/0227592 A1
(43) Pub. Date: Jul. 21, 2022

(54) PERIPHERAL DEVICE WITH GEAR TRAIN PROTECTION

(71) Applicant: Hewlett-Packard Development Company, L.P., Spring, TX (US)

(72) Inventor: Lam Chern Shi, Taipei City (TW)

(73) Assignee: Hewlett-Packard Development Company, L.P., Spring, TX (US)

(21) Appl. No.: 17/608,193

(22) PCT Filed: Sep. 9, 2019
(86) PCT No.: PCT/US2019/050259

§ 371 Date: Nov. 2, 2021

(51) Int. Cl. B65H 5/06; F16D 41/18

(52) U.S. Cl. CPC B65H 5/06; F16D 41/185; B65H 2801/12; B65H 2403/42; B65H 2403/733; B65H 2403/47

(57) ABSTRACT

A gear train assembly comprises a gear train and a motor to drive the gear train. A shaft which is driven by the gear train, a rubber roller engaging the shaft and being co-axial therewith. The gear train also comprises a roller gear disposed on the shaft. The roller gear disengages from a second gear that drives the shaft or the rubber roller in response to pulling of media from the peripheral containing the gear train.

### BACKGROUND

Present examples relate to a peripheral device which utilizes a gear train, for non-limiting example, a printing peripheral device. More specifically, but without limitation, present examples relate to a mechanism or assembly which protects the gear train during operation.

### BRIEF DESCRIPTION OF THE DRAWINGS

Examples are described in further detail below, with reference to the drawings, in which:

FIG. 1 is a schematic side section view of a peripheral device;

FIG. 2 is a schematic view of a gear train and motor;

FIG. 3 is an exploded perspective view of a shaft and gear couple;

FIG. 4 is a side section view of the protection mechanism during rotation in a first direction; and,

FIG. 5 is a side section view of the protection mechanism during rotation in a second direction.

### DETAILED DESCRIPTION

During the print process, end users sometimes pull on the media as it is indexing out of the peripheral device. When an end user pulls on the media, an external force or torque may be applied to the gear train and motor. Over time, or in severe instances, this external force or torque can result in damage to a gear train which controls indexing of the media through the peripheral. Accordingly, these forces may be transmitted through the gear train to the motor to cause damage to, and have negative impact on the wear life, of either or both of the gear train and motor. The present examples provide a gear assembly which will disengage when such external force or torque is applied so as to limit the transmittal of such through the gear train and to the motor.

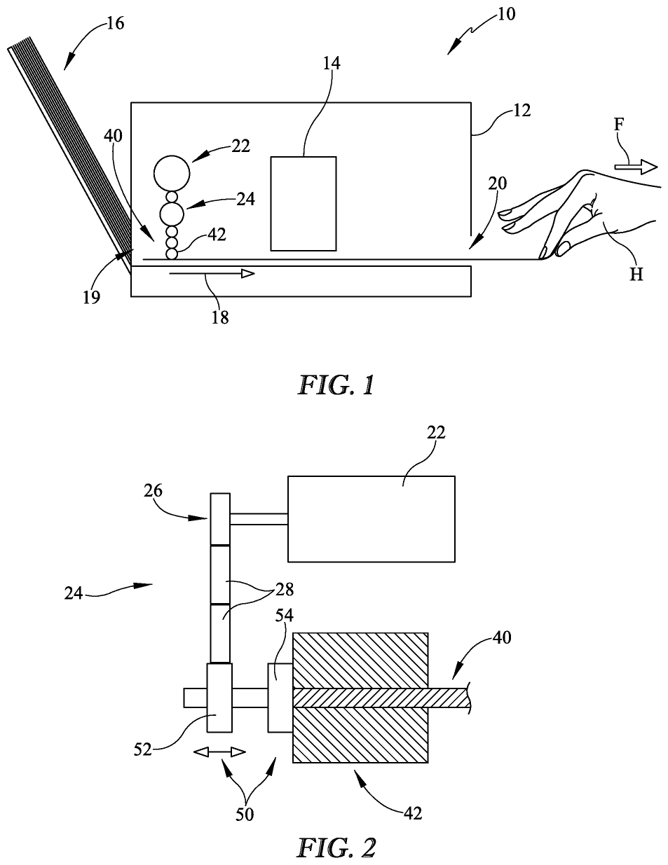

Referring now to FIGS. 1-5, a gear train assembly for a media feeding peripheral device is provided. The gear train provides protection of the gear train and motor from external force applied during operation. More specifically, the gear train allows for opening, or disconnection, of the mechanical communication between the gear train and a shaft when an external force is applied to the system. This disconnect of the mechanical communication through a transmission decreases the likelihood of damage to the gear train or the motor by the external force, such as, for example, an end user pulling on the media being indexed or passed through the peripheral for printing, for example.

Referring now to FIG. 1, a schematic side section view of a peripheral is depicted. The peripheral device may be embodied as a printer, according to some examples, but such description is merely an example and should not be limiting. For example, other peripheral devices may include external finishers that process printed media. The gear train may be used with various devices. The peripheral device 10 that includes a housing 12 and print mechanism 14 which is located within the housing 12. The print mechanism 14 may be, for non-limiting example, a dot-matrix print mechanism, an ink jet print mechanism, or a laser print mechanism. This list is non-exhaustive as other print mechanisms and other devices having motors and gears may be utilized and be within the scope of the instant teaching.

The peripheral device 10 also comprises a gear train 24 which may be utilized to move the print media 16 through the housing 12. The print media 16 may move through a media path 18 which is defined by a media input 19 for the print media 16, a media output 20, and a path therebetween. The gear train 24 rotates in response to rotation of the motor 22 to effectuate movement of the print media 16 through the peripheral. As the print media 16 moves through the housing 12 and is indexed by the gear train 24 and the motor 22, the print media 16 is printed upon to form an image, document, or other desirable print output. The print media 16 may be paper stock, photo media, or any of various materials which may be passed through the peripheral to receive ink or laser toner. The motor 22 may be, but is not limited to, in some examples a stepper motor, and may be fixed in relation to a frame (not shown) within the housing 12 by a fixation component, such as a screw which may engage the frame. The motor 22 receives power via a power input (not shown) to drive the gear train 24. The power input may be an electrical power input or a mechanical power input. In some examples, the motor 22 may be an electric A/C or D/C motor.

Near the media output 20, a hand H is shown grasping the media 16 and a force F is applied to the print media 16 to pull such from the peripheral device 10. As depicted, the print media 16 is still engaging the gear train 24 and indirectly the motor 22. The instant examples serve to protect the gear train 24 and the motor 22 from this application of external force.

As previously noted, this may be detrimental to the longevity of gear trains and/or the motors in prior art systems. Accordingly, the present examples open or disengage the gear train 24 in a manner such that external force F applied by the end user, as depicted in FIG. 1, is not transmitted through the entirety of the gear train 24 and the motor 22.

In the side section view, one can glean that when the sheet is pulled by a user, the torque applied to the gear train 24 increases torque direction applied between those gears as opposed when the motor 22 is driving the gear train 24, even when the media is moving in the same direction through the peripheral device 10. When the motor 22 is driving the print media 16 forward along media path 18, the torque applied to the roller gear 52 (FIG. 2) against a second gear 54 is maintained to keep the gear train 24 closed or engaged. However when the additional external force F of pulling of the print media 16 is applied, the gear train 24 disconnects or separates to inhibit damage to the gear train 24 and/or motor 22.

Referring now to FIG. 2 is a schematic view of the gear train 24 and motor 22 is provided and additionally includes a shaft 40 and rubber roller 42. The motor 22 is shown positioned adjacent to and mechanically engaging the gear train 24. The gear train 24 may include a pinion 26 and gears 28, which drive rotation of the shaft 40 and rubber roller 42. The gear train 24 may include a number of gears some of which may in some examples define subassemblies or carriers of gears in order to provide the transmission between the motor 22 and the rubber roller 42 and shaft 40. It should be understood that the gear train 24 may take various forms and is not limited by number or arrangement of gears. Each of the gears may have a plurality of teeth and any of the gears may be composite or non-composite gears. The various types of gears may include, but are not limited to, spur, helical, face, double helical, rack and pinion, bevel, miter, worm, screw gear and internal gears. Some of the gears may also be housed within a housing if desirable.

The gear train 24 may comprise a gear couple 50 which may engage one another for rotation in one driving direction but which mechanically disengage from one another when an external force is applied to drive rotation in the opposite direction. As depicted, the gear couple 50 may comprise a roller gear 52 and a second gear 54 that causes the disengagement of the roller gear 52 in one direction. The rubber roller 42 may be connected to one of the first and second gears 52, 54 and in the instant example, is located on the shaft 40 and adjacent to the second gear 54. In other examples, the gear couple 50 may be located at other locations along the gear train 24, and therefore is not limited to positioning at the rubber roller 42. The rubber roller 42 engages the print media 16 (FIG. 1) during indexing or driving of the print media 16 through the peripheral device 10, and is engaged with the print media 16 when the scenario occurs that an end user grasps and pulls the print media 16 while the gear train 24 and motor 22 are still operating and engaged with the print media 16 passing through the housing 12 (FIG. 1). While the gear couple 50 is shown located along the roller shaft 40, it should be understood that the gear couple 50 may be located at various positions within the gear train 24.

Further, as will become clear with further reading, the roller gear 52 and the second gear 54 are shown in an exaggerated separated state in FIG. 2. The exaggeration is merely for sake of understanding that the two gears 52, 54 disconnect from one another when the external force is applied. In the instant example, the separation of gears 52, 54 is a lateral separation. Further in some examples, the roller gear 52 may move away laterally from the second gear 54, while in other examples, the second gear 54 may move away from the roller gear 52. Still further, one skilled in the art should recognize that other gears in the gear train 28 may provide the protection of separation.

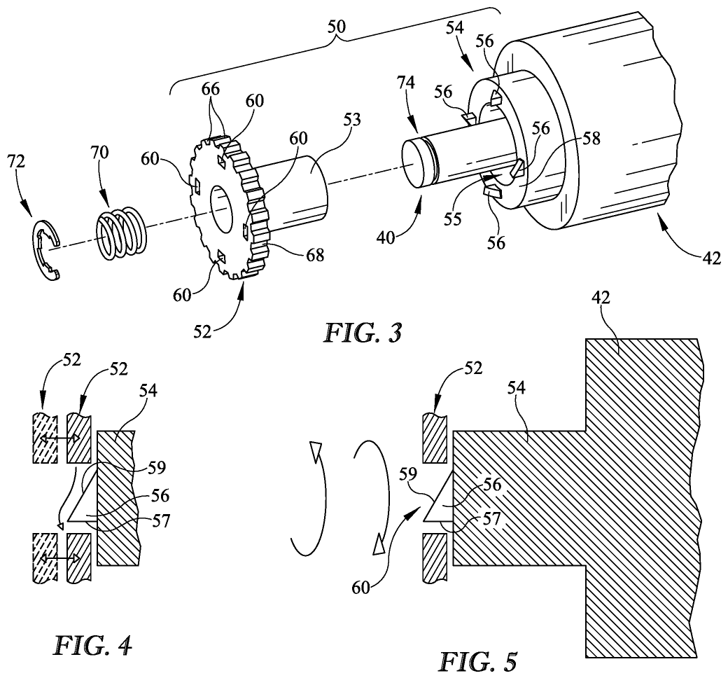

Referring now to FIG. 3, an exploded perspective view of an example roller gear 52 and a rubber roller 42 are shown for ease of description separate of the remaining gear train 24 (FIG. 2). The rubber roller 42 is shown disposed on the shaft 40. The roller gear 52 and the second gear 54 are exploded but when assembled are capable of engaging one another so that the roller gear 52 drives rotation of the second gear 54, the roller shaft 40 and the rubber roller 42. The shaft 40, according to some examples, may be a metallic shaft and the rubber roller 42 may be formed integrally during manufacture of the shaft 40, for example, by molding the rubber roller 42 onto the shaft 40. The term “rubber roller” may comprise various rubber or rubber based materials, plastic materials, or other materials which have some ability to frictionally engage media to drive movement or indexing of print media 16 through a peripheral device. Also depicted on the shaft 40 and adjacent to the rubber roller 42, is the second gear 54 which may be also formed of a rubber or plastic material and engages the roller gear 52. The second gear 54 rotates with the rubber roller 42 during operation by the motor 22 (FIG. 1) or when an end user pulls the print media 16 during operation. The second gear 54 may include teeth 56 which may in some examples extend from a sidewall of the second gear 54. Further, in some examples, the gear teeth 56 may be asymmetrical such that on one side a first driving surface 57 is presented for engagement with the roller gear 52 in order to drive rotation of the shaft 40 and the rubber roller 42. The teeth 56 may also comprise a second surface 59 that may be presented to the roller gear 52 which is angled, tapered, or otherwise formed to provide a lateral force or a lateral component force and movement of the roller gear 52 and cause disengagement of the roller gear 52 and the second gear 54, or alternatively movement of the second gear 54 away from the roller gear 52.

The second gear 54 of the gear couple 50 may be generally circular in cross section and provides the asymmetric teeth 56 on a side surface 58 of the second gear 54 closest to the roller gear 52. The second gear 54 may also be in the form of a collar having a hollow central interior area 55 such that a hub 53 of the roller gear 52 may pass into a hollow area of the second gear 54. As shown in this view, the roller gear 52 and the second gear 54 are coaxial and the roller gear 52 is formed as to allow for lateral movement of the roller gear 52 relative to the shaft 40. The hollow central interior area also allows for close proximity and engagement of the gears 52, 54.

The roller gear 52 may have a plurality of tooth engagement apertures 60 wherein the asymmetric teeth 56 may be positioned. The teeth 56 are positioned in the tooth engagement apertures 60 for engagement by the teeth 56 when the roller gear 52 and the second gear 54 are engaged. When the two gears 52, 54 open or disconnect, the teeth 56 are no longer positioned in the tooth engagement apertures 60.

The view also depicts the engagement of the teeth 56 with the apertures to drive rotation of the second gear 54, shaft 40 and rubber roller 42. The arrangement of the teeth 56 and tooth engagement apertures 60 provides that the first presented surface 57 of the asymmetric teeth 56 drives rotation of the second gear 54. With rotation of gear 52 in a second direction, the second surface 59 of the asymmetric teeth 56 is presented to an edge of the tooth engagement aperture 60, which causes lateral movement of the gear 52 along the shaft 40. The second surface 59 may be angled, tapered, rounded or any of various shapes which cause a lateral force upon engagement by the roller gear 52.

The roller gear 52 may also comprise a plurality of teeth 66 extending about the circumferential surface 68 of the roller gear 52. The teeth 66 allow for engagement with the remainder of the gear train 28 (FIG. 2).

Adjacent to the roller gear 52 is a bias element 70 which may in some examples be in the form of a pressure spring. The bias element 70 forces the roller gear 52 into engagement with the second gear 54 when the teeth 66 are aligned with the tooth engagement apertures 60. The bias element 70 is also elastic which allows for the roller gear 52 to move toward the bias element 70 but force the roller gear 52 back toward its engaged position with the second gear 54. In a normal operating condition, the bias element 70 applies a pressure to the roller gear 52 and forces it toward the second gear 54. In some examples, the bias element 70 may be a compressed spring which pushes the roller gear 52 toward the second gear 54. In other examples, the bias element 70 may be a stretched or tensioned spring placed at the second gear 54 to pull the roller gear 52 toward the second gear 54. In some examples, the direction of bias force and the spring movement will be depend on which gear of a gear couple is moving away from the other. Further, other structures beyond springs may be utilized to bias the roller and gears 52, 54 into engagement when the teeth 66 and the tooth engagement apertures 60 are indexed appropriately.

A retaining clip, or other retention mechanism 72 is shown adjacent to the spring 70. The retention mechanism 72 may engage the shaft 40 to retain the spring 70 and the roller gear 52 on the shaft 40 inhibiting lateral movement beyond a certain preselected allowance or amount of lateral movement. In the instant examples a keyway 74 is provided on the shaft 40 at which location the retention mechanism 72 may be disposed and allows for stationary location of the retention mechanism 72 against which the pressure spring 70 may be biased. In other examples, the keyway 74 may take the form of a hole extending through the shaft 40 and a clip which extends into the hole. In stiff further examples the retaining mechanism may be adhered, formed integrally or otherwise fixed on the shaft 40 to function as a retaining structure.

Referring now to FIG. 4, a side section schematic view of the engagement between the roller gear 52 and the second gear 54 is depicted. The asymmetric teeth 56 are in the form of a wedge shape which has the first surface 57 that engages the roller gear 52 when the roller gear 52 is driving motion of the second gear 54 and rubber roller 42. The second surface 59 may be angled such that when the second surface 59 is presented to the roller gear 52, the roller gear 52 is forced to move laterally (to the left in the depicted figure), as shown in broken line. Once the roller gear 52 is indexed to the next subsequent asymmetric tooth 56, the roller gear 52 is forced by the bias element 70 back to engagement with the second gear 54, which is to the position shown in solid line.

With reference now to FIG. 5, the roller gear 52 and the second gear 54 are again shown. The figure depicted two directions of rotation represented by semicircular arrows. In one direction of rotation of the roller gear 52, the left most arrow, the operational direction of the gear train 28 (FIG. 1) causes movement the movement of the roller gear 52 may cause movement of the second gear 54. However, the second arrow, the right semicircular arrow, shows a net direction of rotation of the roller gear 52 due to the rotation of the rubber roller 42 faster than the normal rotation of the roller gear 52. Alternatively, due to the applied force of pulling the media by an end user, the second gear 54 and the roller gear 52 are rotated due to the external force or torque rather than by the gear train 28 (FIG. 1). The surface 59 of the second gear 54 engages the roller gear 52 and forces the roller gear 52 to move laterally, to the left in the instant figure. It should be further understood that the direction of rotation may be determined in two manners. In normal operation, the direction of rotation is controlled by the gear train and the rotation direction of the roller gear 52. The normal direction of rotation causes the surface 57 of the roller gear 52 to engage and drive rotation of the second gear 54 and the rubber roller 42. The alternate direction, however, may be caused by the user grasping the media, which is engaged to the rubber roller 42 during operation, and causes the second gear 54 to move faster than the roller gear 54. When this occurs, the edge of the tooth engagement aperture 60 engages the surface 59 of the teeth 66 so that the roller gear 52 moves laterally. With this lateral movement, the gear train 24 disengages from the shaft 40 and rubber roller 42. However, the bias element 70, for example a spring, also biases roller gear 52 in the opposite direction toward the second gear 54. With continued rotation of the roller gear 52 via the motor 22, the roller gear 52 indexes the tooth engagement apertures 60 to reengage the asymmetric teeth 66 when aligned.

While the foregoing is directed to the various examples described, other and further examples may be devised without departing from the basic scope of the claims that follow. For example, the present examples contemplate that any of the features shown in any of the examples described herein, or incorporated by reference herein, may be incorporated with any of the features shown in any of the other examples described herein, or incorporated by reference herein, and still fall within the scope of the present claims.

1. A gear train assembly for a media feeding peripheral device, comprising:
a gear train;
a motor to drive the gear train;
a shaft which is driven by the gear train, a rubber roller that engages the shaft and is co-axial therewith; and,
a roller gear disposed on the shaft;
wherein the roller gear is to disengage from a second gear that drives the shaft or the rubber roller in response to an external force applied to a media from the peripheral device containing the gear train.

2. The gear train assembly of claim 1 further comprising a bias element which is to disengage the roller gear and the rubber roller.

3. The gear train assembly of claim 2, wherein the bias element is to laterally separate or force together the roller gear and the second gear.

4. The gear train assembly of claim 1, wherein the roller gear is to rotate freely in one of two directions and is to rotate with the second gear and roller in a second of the two directions.

5. The gear train assembly of claim 1, wherein the second gear is mounted on the shaft and engages the rubber roller.

6. The gear train assembly of claim 5, further comprising one of a plurality of asymmetric teeth or a plurality of tooth engagement apertures, on the second gear.

7. The gear train assembly of claim 6, wherein the roller gear has another of a plurality of asymmetric teeth or a plurality of tooth engagement apertures.

8. The gear train assembly of claim 5 further comprising a plurality of asymmetric teeth on the second gear which force the roller gear laterally.

9. The gear train assembly of claim 1 wherein the roller gear and the roller comprise a rubber material.

10. The gear train assembly of claim 1, wherein the second gear is formed integrally with the shaft.

11. A gear train assembly for a media feeding peripheral device, comprising:
a roller gear disposed on a shaft having a roller;
wherein in a first direction of rotation of the roller gear, the roller gear is to drive rotation of the roller;
wherein in a second direction of rotation of the roller, one of the roller gear or the roller is to laterally move away from the other of the roller gear or the roller so as to disengage.

12. The gear train assembly of claim 11 wherein the roller gear is formed integrally with the shaft.

13. The gear train assembly of claim 12 wherein the roller gear is forced in one lateral direction with one direction of rotation and biased in a second lateral direction by a bias element.

14. A gear train assembly for a media feeding peripheral device, comprising:
a motor which drives motion of a gear train;
a shaft which is driven by the gear train;
a roller disposed on the shaft;
wherein the motor is to drive rotation of the gear train, the shaft, and the roller in an operational rotational direction; and,
wherein in response to an external force applied to pull media from the peripheral device, to rotate a second gear and force a roller gear laterally and disengage from the roller second gear.

15. The gear train assembly of claim 14, wherein the second gear is either formed integrally with the shaft or the roller gear is laterally movable toward and away from the roller.
